(19) United States
(12) Patent Application Publication
(10) Pub. No.: US 2025/0307520 A1
(43) Pub. Date: Oct. 2, 2025

(54) ALTERNATIVE DESIGN SELECTION IN INTEGRATED CIRCUIT GENERATION

(71) Applicant: INTERNATIONAL BUSINESS MACHINES CORPORATION, ARMONK, NY (US)

(72) Inventors: UMA SRINIVASAN, POUGHKEEPSIE, NY (US); WILLIAM J. CLARKE, POUGHKEEPSIE, NY (US); MICHAEL SPERLING, POUGHKEEPSIE, NY (US)

(21) Appl. No.: 18/616,909

(22) Filed: Mar. 26, 2024

(51) Int. Cl. G06F 30/398; G06F 111/20; G06F 119/02; G06F 119/22

(52) U.S. Cl. CPC G06F 30/398; G06F 2111/20; G06F 2119/02; G06F 2119/22

(57) ABSTRACT

Alternative design selection in integrated circuit generation includes generating an integrated circuit design including a first set of components configured to optimize a first metric, a second set of components configured to optimize a second metric different than the first metric, and a first selection component configured to select between use of the first set of components or the second set of components. An integrated circuit is caused to be generated based on the integrated circuit design.

### BACKGROUND

The present disclosure relates to methods, apparatus, and products for alternative design selection in integrated circuit generation.

### SUMMARY

According to embodiments of the present disclosure, various methods, apparatus and products for alternative design selection in integrated circuit generation are described herein. In some aspects, alternative design selection in integrated circuit generation includes generating an integrated circuit design including a first set of components configured to optimize a first metric, a second set of components configured to optimize a second metric different than the first metric, and a first selection component configured to select between use of the first set of components or the second set of components. An integrated circuit is caused to be generated based on the integrated circuit design.

### BRIEF DESCRIPTION OF THE DRAWINGS

FIG. 1 sets forth an example computing environment according to aspects of the present disclosure.

FIG. 2 sets forth a block diagram of an integrated circuit with a selector component for alternative design selection according to aspects of the present disclosure.

FIG. 3 sets forth a block diagram of an integrated circuit with multiple selector components for alternative design selection according to aspects of the present disclosure.

FIG. 4 sets forth a block diagram of an integrated circuit with a selector component for alternative design selection according to further aspects of the present disclosure.

FIG. 5 sets forth a flowchart of an example method for performing alternative design selection in integrated circuit generation according to aspects of the present disclosure.

FIG. 6 sets forth a flowchart of an example method for performing alternative design selection in integrated circuit generation according to further aspects of the present disclosure.

### DETAILED DESCRIPTION

The generation of an integrated circuit (i.e., chip) involves a number of phases including the logic design, physical synthesis, routing, and manufacturing phases. Each of the phases can include multiple processes that can be performed iteratively. The logic design can provide a register transfer level (RTL) description. The physical synthesis phase includes identifying and placing components, such as gate logic, to implement the logic design. After optimizing timing and clocks, a netlist can be produced to indicate the interconnections among components. In the routing phase, the placement of wires that connect gates and other components in the netlist is defined. In the manufacturing phase, the finalized design is provided for physical implementation of the chip. The chip may be designed according to a hierarchical design methodology such that the chip is divided into functional circuit components or elements. The logic design and component placement result in a physical implementation that meets the design and performance requirements of the chip.

Design for manufacturing (DFM) refers to various “design rules” that are implemented during the design of integrated circuits to improve the manufacturability of the integrated circuits. More specifically, design rules are rules that are intended to ensure that integrated circuits can be manufactured with economical yields and ensure that integrated circuits possess sufficient reliability in operation. Design rules are often set by semiconductor manufacturers (i.e., “foundries”) based on manufacturing process constraints. In particular, the trend towards smaller and smaller nodes has challenged foundries to overcome the limitations of various photolithographic, chemical, and mechanical processes with respect to the accuracy and the precision of feature dimensions and positioning. For example, diffraction effects and variations in mask placement, depth of focus, and light intensity can affect the accuracy and precision with which shapes (i.e., integrated circuit components) can be patterned on wafers. Integrated circuit designs that do not account for such effects can result in higher rates of manufacturing defects occurring due, for example, to pinched, broken, or shorted components. To improve yields and reliability, foundries often specify design rules that control various dimensional parameters of integrated circuit designs by mandating, among other things, minimum space checks, minimum width checks, minimum area overlap checks, and minimum area variability checks on integrated circuit designs prior to accepting an integrated circuit design for fabrication. As process nodes have become smaller and smaller, foundries have generally implemented design rules of increasing complexity.

The components for an integrated circuit design may be chosen to give the best yield or any other best fit of metrics. However, when a chip is built, there may be variations in process and design behavior, and no accurate way to predict the best solution before hardware. One may have designed what is believed to be a best possible design, but the design may still result in a poor metric (e.g., poor yield or higher than acceptable power). The design decision to optimize reliability or yield is made in the design phase of the chip and not post hardware, and there is no hardware feedback included in the optimization for reliability (or power or temperature) without another iteration of the design.

Some examples disclosed herein are directed to a method for optimizing reliability for yield by selectable components post build. Some examples disclosed herein provide more than one best design in hardware that may be selected only if needed based on yield (or based on reliability or any other metric). Circuits or circuit components may be selected post build based on reliability and/or one or more other metrics. This is particularly useful in a design where there is variation during the manufacturing process. The best design option may be chosen based on the design goals while trading off, for example, reliability for yield, temperature, power, timing, etc. The yield versus reliability tradeoff (or other tradeoff) options are designed into the integrated circuit to, for example, end up with a better yielding product. The selection for individual integrated circuits may be implemented during manufacturing after testing results have been obtained.

Some examples disclosed herein defer certain design decisions until individual chips are manufactured and their physical parameters are known. A selection device may be placed in the application specific integrated circuit (ASIC) logic that allows selection between, for example, internal reference circuits and external reference circuits. The external circuits may only be used when measurement of the specific instance of the chip demonstrates a need. The circuit that is not selected may be used as a spare with a fail-over mechanism to switch to this circuit if the selected circuit fails in the field. The selection decision can be made after fabrication (post hardware) based on hardware test results, rather than during the design of the product (when manufacturing variation is unknown), and there is no need to estimate yield optimization based on layout pre-fabrication.

In some examples, a balance is found between yield and reliability. ASIC manufacturing variability may induce a design decision between using large guard bands (which degrade yield) or external structures (which degrade reliability). The ASIC may be manufactured with larger guard bands with the accompanying loss in yield. Yield loss may be recaptured by enabling the selection device and adding external components. Yield is protected by using external devices. Reliability is protected by limiting the external devices to only those chips that fail to meet the tighter guard band.

In some examples, a minimum chip power may be desirable for yield, reliability, sustainability, etc. ASIC manufacturing variability may preclude knowing a best design before the chip is built. In such examples, the ASIC may be manufactured and tested with alternative power regulation designs to determine which is best for this specific chip instance, and the best performing regulation is selected. The external components may be mounted only when measurement of the specific instance of a chip demonstrates a need.

An example of the present disclosure is directed to a method of performing alternative design selection in integrated circuit generation, which includes generating an integrated circuit design including a first set of components configured to optimize a first metric, a second set of components configured to optimize a second metric different than the first metric, and a first selection component configured to select between use of the first set of components or the second set of components. The method includes causing an integrated circuit to be generated based on the integrated circuit design.

The method may further include causing the first selection component to select one of the first set of components or the second set of components to be used in the integrated circuit based on testing of the integrated circuit. In some examples of the method, the first metric is yield and the second metric is reliability. In some examples of the method, the first set of components is an internal set of components and the second set of components is an external set of components. In some examples of the method, the first set of components is an internal reference voltage circuit and the first metric is reliability, and the second set of components is an external reference voltage circuit and the second metric is yield.

In some examples of the method, the first selection component is configured to select between use of the first set of components or the second set of components in a first part of the integrated circuit, and the integrated circuit design includes second selection component configured to select between use of the first set of components or the second set of components in a second part of the integrated circuit.

In some examples of the method, the first set of components is an on-chip voltage regulator module and the second set of components is an off-chip voltage regulator module. In some examples of the method, the first set of components is a primary regulated power supply and the second set of components is an alternate regulated power supply.

Another example of the present disclosure is directed to an apparatus, which includes a processing device. The apparatus includes a memory operatively coupled to the processing device, wherein the memory stores computer program instructions that, when executed, cause the processing device to: generate an integrated circuit design including a first set of components configured to optimize a first metric, a second set of components configured to optimize a second metric different than the first metric, and a first selection component configured to select between use of the first set of components or the second set of components; and cause an integrated circuit to be generated based on the integrated circuit design.

In some examples of the apparatus, the memory stores computer program instructions that, when executed, further cause the processing device to: cause the first selection component to select one of the first set of components or the second set of components to be used in the integrated circuit based on testing of the integrated circuit. In some examples of the apparatus, the first metric is yield and the second metric is reliability. In some examples of the apparatus, the first set of components is an internal set of components and the second set of components is an external set of components. In some examples of the apparatus, the first set of components is an internal reference voltage circuit and the first metric is reliability, and the second set of components is an external reference voltage circuit and the second metric is yield.

In some examples of the apparatus, the first selection component is configured to select between use of the first set of components or the second set of components in a first part of the integrated circuit, and the integrated circuit design includes second selection component configured to select between use of the first set of components or the second set of components in a second part of the integrated circuit.

In some examples of the apparatus, the first set of components is an on-chip voltage regulator module and the second set of components is an off-chip voltage regulator module. In some examples of the apparatus, the first set of components is a primary regulated power supply and the second set of components is an alternate regulated power supply.

Another example of the present disclosure is directed to a computer program product comprising a computer readable storage medium, wherein the computer readable storage medium comprises computer program instructions that, when executed: generate an integrated circuit design including a first set of components configured to optimize a first metric, a second set of components configured to optimize a second metric different than the first metric, and a first selection component configured to select between use of the first set of components or the second set of components; and cause an integrated circuit to be generated based on the integrated circuit design.

In some examples of the computer program product, the computer readable storage medium comprises computer program instructions that, when executed: cause the first selection component to select one of the first set of components or the second set of components to be used in the integrated circuit based on testing of the integrated circuit. In some examples of the computer program product, the first metric is yield and the second metric is reliability. In some examples of the computer program product, the first set of components is an internal set of components and the second set of components is an external set of components.

A technical challenge with integrated circuit design and building is that, when a chip is built, there may be variations in process and design behavior, and there may be no accurate way to predict the best solution before hardware. The design decision to optimize reliability or yield is made in the design phase of the chip and not post hardware, and there is no hardware feedback included in the optimization for reliability (or power or temperature) without another iteration of the design.

Examples of the present disclosure facilitate technical solutions that address the above described technical challenges without the drawbacks of existing solutions. Some examples disclosed herein provide more than one best design in hardware that may be selected only if needed based on yield (or based on reliability or any other metric). This is particularly useful in a design where there is variation during the manufacturing process. The best design option may be chosen based on the design goals while trading off, for example, reliability for yield, temperature, power, timing, etc. The yield versus reliability tradeoff (or other tradeoff) options are designed into the integrated circuit to, for example, end up with a better yielding product. Examples of the present disclosure improve the design and manufacturing of integrated circuit chips and provide an improvement to computing technology. Examples of the present disclosure accordingly provide a practical application to the technical challenges described herein in the field of computing technology and particularly electrical circuits used in computing devices.

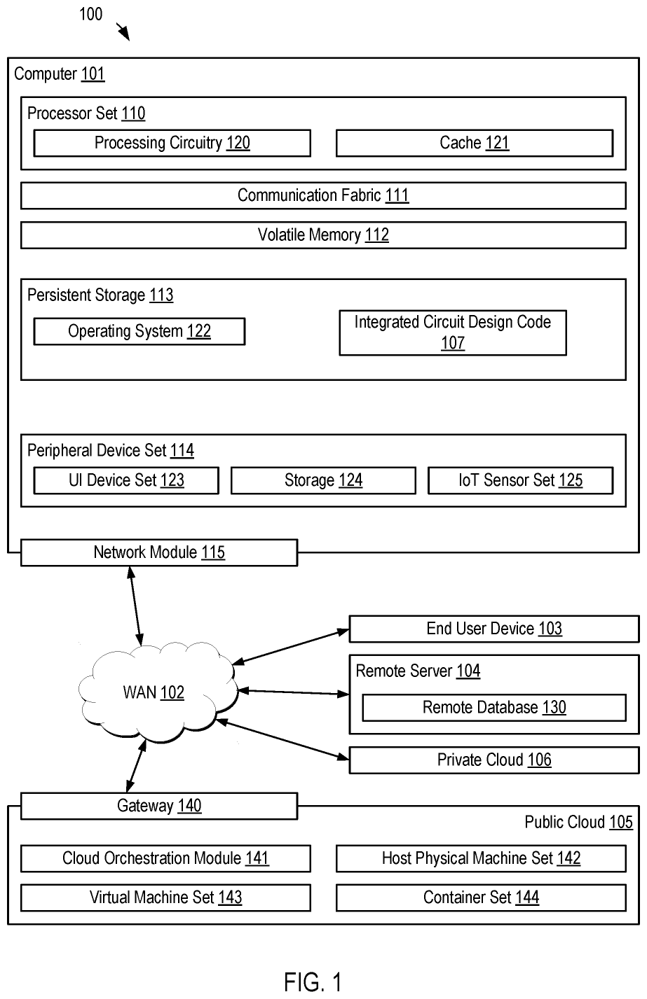

FIG. 1 sets forth an example computing environment according to aspects of the present disclosure. Computing environment 100 contains an example of an environment for the execution of at least some of the computer code involved in performing the various methods described herein, such as integrated circuit design code 107. In addition to integrated circuit design code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and integrated circuit design code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in integrated circuit design code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in integrated circuit design code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

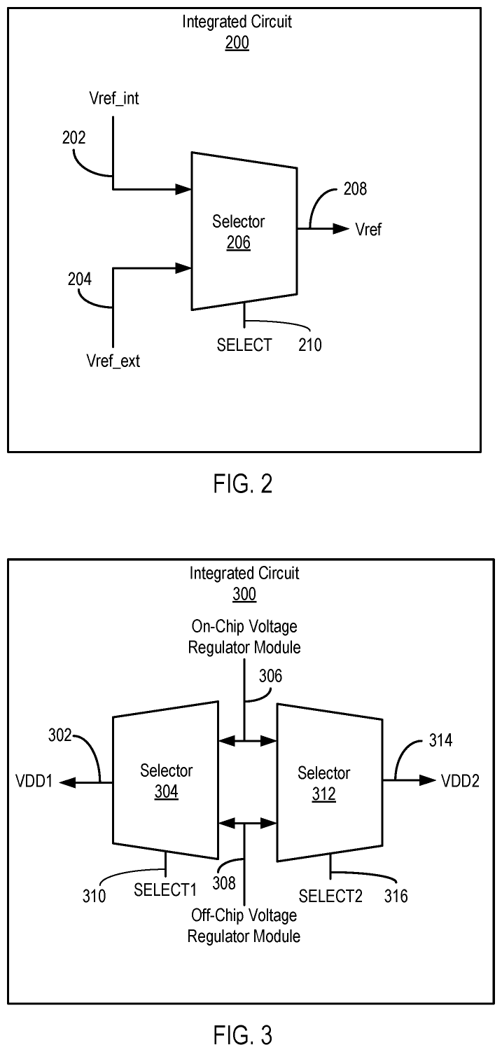

FIG. 2 sets forth a block diagram of an integrated circuit 200 with a selector component for alternative design selection according to aspects of the present disclosure. Integrated circuit 200 may be designed using integrated circuit design code 107 (FIG. 1). In some examples, integrated circuit 200 is an ASIC. In some examples, integrated circuit 200 may include an internal circuit, such as an SRAM, which uses a reference voltage, Vref. Integrated circuit 200 includes a selector component 206 having inputs 202 and 204, output 208, and control signal input 210. The selector component 206 may be a scan-only latch, eFuse, or another type of component for selecting among a plurality of inputs. Input 202 of selector component 206 is configured to be coupled to a Vref_int reference voltage, which is an internal (on-chip) generated reference voltage that has a high reliability but is yield limiting. Input 204 of selector component 206 is configured to be coupled to a Vref_ext reference voltage, which is an external (off-chip) generated reference voltage that is not yield limiting, but its external components and connectors reduce reliability.

Selector component 206 also includes a control signal input 210 to receive a SELECT signal that indicates which of the two inputs 202 and 204 will be output from selector component 206. The selected input is output as reference voltage, Vref, via output 208 of the selector component 206. The choice of best solution (e.g., internal vs. external reference voltage) may not be known until data from chip manufacturing is available. The data may be unknown during chip design and may change wafer to wafer. Examples disclosed herein enable a best solution to be selected post-silicon after chip data is available. In some examples, most chips will use the internal circuit, and overall reliability will not be significantly impacted by a small number of chips using external components.

FIG. 3 sets forth a block diagram of an integrated circuit 300 with multiple selector components for alternative design selection according to aspects of the present disclosure. Integrated circuit 300 may be designed using integrated circuit design code 107 (FIG. 1). In some examples, integrated circuit 300 is an ASIC. Some parts of a chip may need higher voltage to achieve the same performance levels as the rest of the chip. This issue may be addressed by using dedicated on-chip regulators per chiplet. These regulators may be more reliable than off-chip voltage regulator module (VRM) components but may suffer yield loss due to accuracy. Integrated circuit 300 addresses this issue by providing the ability to select between on-chip (more reliable) versus off-chip (less reliable) voltage regulator modules. This selection may be individually made for specific chiplets after the design is complete and yield data has been obtained.

Integrated circuit 300 includes selector components 304 and 312 having common inputs 306 and 308. Selector component 304 includes output 302 and control signal input 310. Selector component 312 includes output 314 and control signal input 316. The selector components 304 and 312 may be scan-only latches, eFuses, or another type of components for selecting among a plurality of inputs. Input 306 of selector components 304 and 312 is configured to be coupled to an on-chip voltage regulator module, which is an internal to the integrated circuit 300 and has a high reliability but is yield limiting. Input 308 of selector components 304 and 312 is configured to be coupled to an off-chip voltage regulator module, which is external to the integrated circuit 300 and is not yield limiting, but its external components and connectors reduce reliability.

Selector component 304 includes a control signal input 310 to receive a SELECT1 signal that indicates which of the two inputs 306 and 308 will be output from selector component 304. The selected input is output as voltage, VDD1, via output 302 of the selector component 304. Selector component 312 includes a control signal input 316 to receive a SELECT2 signal that indicates which of the two inputs 306 and 308 will be output from selector component 312. The selected input is output as voltage, VDD2, via output 314 of the selector component 312. The choice of best solution (e.g., on-chip VRM vs. off-chip VRM) may not be known until data from chip manufacturing is available. The data may be unknown during chip design and may change wafer to wafer. Examples disclosed herein enable a best solution to be selected post-silicon after chip data is available. In some examples, most chips will use the on-chip VRM, and overall reliability will not be significantly impacted by a small number of chips using an off-chip VRM.

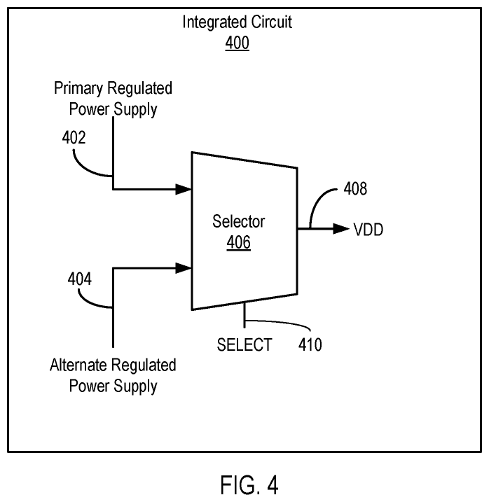

FIG. 4 sets forth a block diagram of an integrated circuit 400 with a selector component for alternative design selection according to further aspects of the present disclosure. Integrated circuit 400 may be designed using integrated circuit design code 107 (FIG. 1). In some examples, integrated circuit 400 is an ASIC. Some chips may be power-limited, and higher power may lower the reliability of the chip over time. Integrated circuit 400 addresses this issue by providing the ability to select an alternate regulated power supply as a low power option for the chip rather than using the primary regulated power supply. Integrated circuit 400 includes a selector component 406 having inputs 402 and 404, output 408, and control signal input 410. The selector component 406 may be a scan-only latch, eFuse, or another type of component for selecting among a plurality of inputs. Input 402 of selector component 406 is configured to be coupled to a primary regulated power supply. Input 404 of selector component 406 is configured to be coupled to an alternate regulated power supply.

Selector component 406 also includes a control signal input 410 to receive a SELECT signal that indicates which of the two inputs 402 and 404 will be output from selector component 406. The selected input is output as voltage, VDD, via output 408 of the selector component 406. The choice of best solution (e.g., primary regulated power supply vs. alternate regulated power supply) may not be known until data from chip manufacturing is available. The data may be unknown during chip design and may change wafer to wafer. Examples disclosed herein enable a best solution to be selected post-silicon after chip data is available. In some examples, most chips will use the primary regulated power supply, and the post-hardware choice to use the alternate regulated power supply may only be made for chips that are exceeding the power budget, thus limiting usage of the alternate regulated power supply, while improving system reliability.

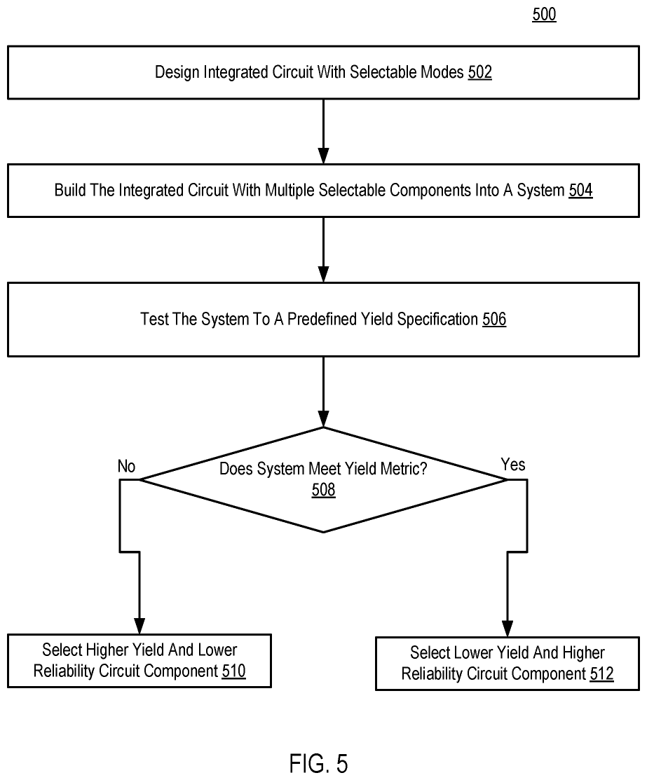

FIG. 5 sets forth a flowchart of an example method 500 for performing alternative design selection in integrated circuit generation according to aspects of the present disclosure. In a particular embodiment, the method 500 is performed utilizing the integrated circuit design code 107 (FIG. 1). The method 500 includes designing 502 an integrated circuit with selectable modes. In some examples, the modes include a first mode that corresponds to a first design choice and uses one or more higher yield and lower reliability circuit components, and a second mode that corresponds to a second design choice and uses one or more lower yield (e.g., lower than the first mode) and higher reliability (e.g., higher than the first mode) circuit components. The method 500 further includes building 504 the integrated circuit with multiple selectable components into a system. In some examples, each of the multiple selectable components corresponds to one of the selectable modes. The method 500 further includes testing 506 the system to a predefined yield specification.

At 508, the method 500 includes determining whether the system meets a yield metric. If it is determined at 508 that the system does not meet the yield metric, the method 500 moves to 510 to select a higher yield and lower reliability circuit component. In some examples, the higher yield and lower reliability circuit component is external to the integrated circuit. If it is determined at 508 that the system does not meet the yield metric, the method 500 moves to 512 to select a lower yield and higher reliability circuit component. In some examples, the lower yield and higher reliability circuit component is internal to the integrated circuit. In some examples of method 500, net reliability is high because higher reliability components are selected in most cases except when impacting yield.

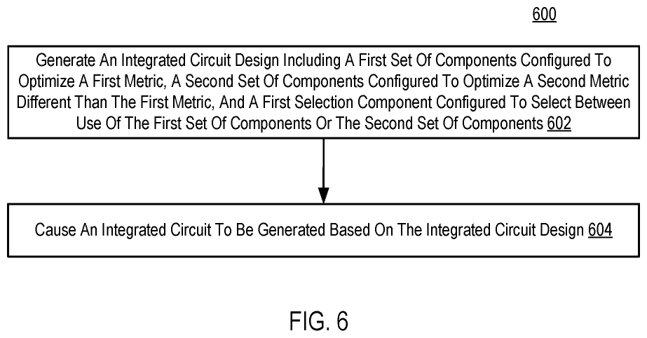

FIG. 6 sets forth a flowchart of an example method 600 for performing alternative design selection in integrated circuit generation according to further aspects of the present disclosure. In a particular embodiment, the method 600 is performed utilizing the integrated circuit design code 107 (FIG. 1). The method 600 includes generating 602 an integrated circuit design including a first set of components configured to optimize a first metric, a second set of components configured to optimize a second metric different than the first metric, and a first selection component configured to select between use of the first set of components or the second set of components. The method 600 further includes causing 604 an integrated circuit to be generated based on the integrated circuit design.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of performing alternative design selection in integrated circuit generation, comprising:
generating an integrated circuit design including a first set of components configured to optimize a first metric, a second set of components configured to optimize a second metric different than the first metric, and a first selection component configured to select between use of the first set of components or the second set of components; and
causing an integrated circuit to be generated based on the integrated circuit design.

2. The method of claim 1, and further comprising:
causing the first selection component to select one of the first set of components or the second set of components to be used in the integrated circuit based on testing of the integrated circuit.

3. The method of claim 1, wherein the first metric is yield and the second metric is reliability.

4. The method of claim 1, wherein the first set of components is an internal set of components and the second set of components is an external set of components.

5. The method of claim 1, wherein the first set of components is an internal reference voltage circuit and the first metric is reliability, and wherein the second set of components is an external reference voltage circuit and the second metric is yield.

6. The method of claim 1, wherein the first selection component is configured to select between use of the first set of components or the second set of components in a first part of the integrated circuit, and wherein the integrated circuit design includes second selection component configured to select between use of the first set of components or the second set of components in a second part of the integrated circuit.

7. The method of claim 6, wherein the first set of components is an on-chip voltage regulator module and the second set of components is an off-chip voltage regulator module.

8. The method of claim 1, wherein the first set of components is a primary regulated power supply and the second set of components is an alternate regulated power supply.

9. An apparatus comprising:
a processing device; and
memory operatively coupled to the processing device, wherein the memory stores computer program instructions that, when executed, cause the processing device to:
generate an integrated circuit design including a first set of components configured to optimize a first metric, a second set of components configured to optimize a second metric different than the first metric, and a first selection component configured to select between use of the first set of components or the second set of components; and
cause an integrated circuit to be generated based on the integrated circuit design.

10. The apparatus of claim 9, wherein the memory stores computer program instructions that, when executed, further cause the processing device to:
cause the first selection component to select one of the first set of components or the second set of components to be used in the integrated circuit based on testing of the integrated circuit.

11. The apparatus of claim 9, wherein the first metric is yield and the second metric is reliability.

12. The apparatus of claim 9, wherein the first set of components is an internal set of components and the second set of components is an external set of components.

13. The apparatus of claim 9, wherein the first set of components is an internal reference voltage circuit and the first metric is reliability, and wherein the second set of components is an external reference voltage circuit and the second metric is yield.

14. The apparatus of claim 9, wherein the first selection component is configured to select between use of the first set of components or the second set of components in a first part of the integrated circuit, and wherein the integrated circuit design includes second selection component configured to select between use of the first set of components or the second set of components in a second part of the integrated circuit.

15. The apparatus of claim 14, wherein the first set of components is an on-chip voltage regulator module and the second set of components is an off-chip voltage regulator module.

16. The apparatus of claim 9, wherein the first set of components is a primary regulated power supply and the second set of components is an alternate regulated power supply.

17. A computer program product comprising a computer readable storage medium, wherein the computer readable storage medium comprises computer program instructions that, when executed:
generate an integrated circuit design including a first set of components configured to optimize a first metric, a second set of components configured to optimize a second metric different than the first metric, and a first selection component configured to select between use of the first set of components or the second set of components; and
cause an integrated circuit to be generated based on the integrated circuit design.

18. The computer program product of claim 17, wherein the computer readable storage medium comprises computer program instructions that, when executed:
cause the first selection component to select one of the first set of components or the second set of components to be used in the integrated circuit based on testing of the integrated circuit.

19. The computer program product of claim 17, wherein the first metric is yield and the second metric is reliability.

20. The computer program product of claim 17, wherein the first set of components is an internal set of components and the second set of components is an external set of components.
